(19) United States
(12) Patent Application Publication
(10) Pub. No.: US 2009/0039107 A1
(43) Pub. Date: Feb. 12, 2009

(54) IN-STORE TESTER DEVICE AND METHOD

(75) Inventors: Srini Sripada, Stamford, CT (US); Gina Marie Stefanik, Edina, MN (US); Jeffrey Joseph Hofmann, Eagan, MN (US)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., D/B/A UNILEVER, Englewood Cliffs, NJ (US)

(21) Appl. No.: 12/188,384

(22) Filed: Aug. 8, 2008

Related U.S. Application Data
(60) Provisional application No. 60/955,050, filed on Aug. 10, 2007.

(51) Int. Cl. G01F 11/00; B67D 5/00; B67D 5/06; B65D 35/56

(52) U.S. Cl. 222/1; 222/23; 222/63; 222/105; 222/108

(57) ABSTRACT

A device and method is provided which allows a consumer prior to purchase to test a skin lotion or cream product in a retail establishment. The device includes a housing sealed against entry by the consumer and having external walls with at least three panel areas for communicating marketing information. A reservoir within the housing stores the product. A dispensing outlet allows exit from the reservoir of a unit sample of product. A motion sensor on the device detects the consumer's hand near an area of the outlet. A drip tray beneath the outlet collects any wastage of the sample not intercepted by the consumer's hand.

### BACKGROUND OF THE INVENTION

1. Field of the Invention

The invention concerns a device and method which allows a consumer prior to purchase to test a skin lotion or cream product which is located in a retail establishment.

2. The Related Art

Department and many specialty cosmetic stores have counters displaying open packages for allowing consumers to test products. Some of these products are open jars of cream. More frequently test samples are liquids in pump dispenser bottles. Usually there is very little supervision in the sampling. Chances are high for microbial contamination. Although apparently secure, even pump bottles are sometimes unscrewed so a consumer can more accurately smell the fragrance component of a lotion/cream on display.

Another drawback of the known in-store tester devices is their small capacity. In high traffic areas, the normal sized package can rapidly be exhausted. There is not always someone around to set up a replacement.

A still further problem with the known art is that a cosmetic manufacturer is not provided with any feedback information on customer use of the testers. Information on traffic through a particular area of the store would be most useful. Additionally, it would be desirable to have an in-store tester with capability for some limited advertising.

Automated cosmetic dispensing machines have been deployed in the marketplace. For instance, the Elizabeth Arden Company provided on its department store counters an apparatus to dispense customized facial foundation products. A description of the method and apparatus is found in U.S. Pat. No. 5,785,960 (Rigg et al.) and U.S. Pat. No. 5,622,692 (Rigg et al.), as well as U.S. Pat. No. 4,871,262 (Krauss et al.). The Arden machines were equipped to dispense a full product rather than being an in-store sample testing dispenser. Not resolved was the basic problem of product replenishment of the machine reservoirs.

Accordingly, it is an object of the present invention to provide an in-store tester in a retail environment which can avoid microbial contamination issues, alert manufacturer and store to need for replacement samples, report store traffic patterns and serve advertising purposes.

### SUMMARY OF THE INVENTION

A device is provided which allows a consumer prior to purchase to test a skin lotion or cream product in a retail establishment, the device including:
a housing formed from recycled plastic and sealed from entry by the consumer, external walls of the housing having at least three panel areas for communicating marketing information;
at least one electrical battery within the housing;
a reservoir within the housing for storing the product;
a dispensing outlet allowing exit from the reservoir of a unit sample of the product;
a motion sensor for detecting presence of a consumer's hand near an area of the outlet; and
a drip tray beneath the outlet for collecting any wastage of the sample not intercepted by the consumer's hand.

### BRIEF DESCRIPTION OF THE DRAWING

Further advantages, features and objects of the present invention will better be understood through consideration of the following drawing in which:

FIG. 1 is a front elevational view of an in-store tester device according to the present invention; and

FIG. 2 is a cross-sectional view of the device along line II-II of FIG. 1.

### DETAILED DESCRIPTION OF THE INVENTION

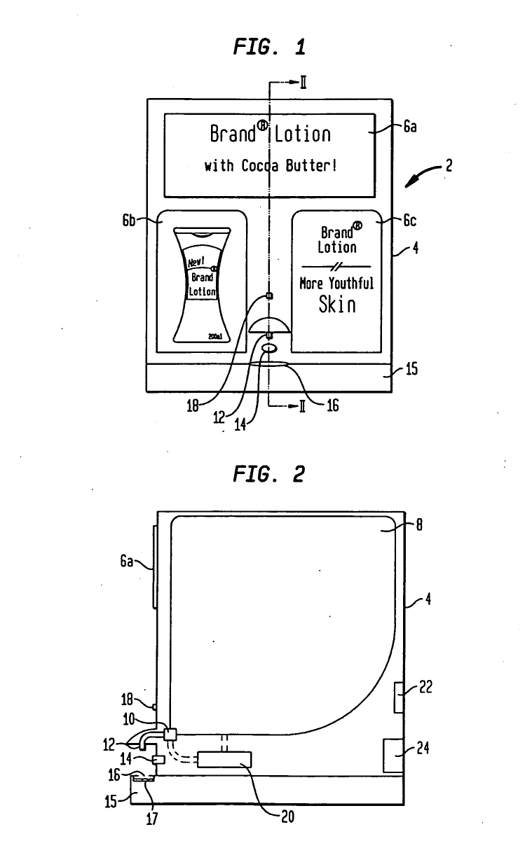

FIG. 1 illustrates a device 2 according to the present invention. The device is intended for placement on a shelf of a retail store alongside rows of plastic bottles containing purchasable product identical to that being dispensed from the in-store tester device. A consumer prior to purchase can sample a dollop of the cream or lotion product from the tester.

The device includes a housing 4 formed from a recyclable plastic. The housing (except for SD card and battery) will be factory sealed to prevent consumer entry into the housing. Sealing is important to prevent outside microbial or other contamination of the tester product. Since the device is intended for mass market store shelves, there will be very little supervision regarding use and misuse of the device or its components. Sealed security is therefore of prime importance.

External walls of the housing will have at least three panel areas 6a, 6b and 6c for communicating marketing information. Particularly desirable for display on at least one of the panel areas is an image of the retail packaging for the product which has been dispensed for testing. This image of the packaging will direct a potential customer to the appropriate packaged product (e.g. lotion bottle) stocked adjacently on the same shelf or nearby the device. Different variants of the same brand or even different brand products could inadvertently and confusingly be selected by the customer. For this reason the package image (which may include color coding, package shape, brand name, brand subname and general graphics) will be helpful to the consumer to connect and then purchase the appropriate packaged product.

Flowable lotion or cream is stored within a reservoir 8 within the housing. This reservoir may be directly formed from interior walls of the housing or could be a relatively thin-walled flexible pouch. Capacity of the reservoir for flowable product may range from about 500 ml to 10,000 ml, preferably from about 700 to about 5,000 ml.

The product is intended for instant use on the skin subsequent to being sampled. Leave-on skin lotions and creams are suitable for this device. Other cosmetic products such as shampoos or body wash may not be appropriate for in-store testing through the present device because they require water to activate foaming surfactants within these formulas. Skin lotions and creams generally may include water, emollients, preservatives, fragrances, humectants, colorants, antioxidants, vitamins, herbal extracts, thickeners and combinations of these components.

Emulsifiers may be present in amounts from about 0.1 to about 10%, preferably from 0.3 to about 5%, optimally from about 0.8 to about 3% by weight of the lotion or cream. Foaming surfactants, particularly in amounts in excess of 5% by weight of the composition, ordinarily will not be included in the skin lotions or creams. The latter are not intended to have any significant foaming properties.

A control valve 10 will be present downstream from the reservoir. A dispensing outlet 12 downstream from the valve will allow exit of a unit sample of the product from the reservoir. Dispensing at the outlet will be activated by detection from a motion sensor 14 of the presence of a consumer's hand near an area of the outlet. The detection of motion sends a signal from the sensor to the valve instructing movement to an open position. Infrared light is the preferred vector for motion detection in a sensor.

A drip tray 15 is arranged beneath the outlet. The tray collects any wastage of the sample not intercepted by the consumer's hand. The drip tray has a product capacity which may range from about 5 to about 25%, preferably from about 10 to about 20%, optimally about 15% by volume of initially fully filled reservoir. In a roof of the drip tray is a receiving aperture 16. This aperture is aligned directly below the dispensing outlet 12 functioning to receive dispensed sample not intercepted by the consumer's hand. A retractable closure door 17 is deployed across the aperture. A spring connected to a servomotor which receives an activation signal from the motion detection sensor retracts the closure door from across the aperture. Normally the door is in a position to seal the aperture. This prevents consumers from sticking fingers and/or objects inside the drip tray. Safety is ensured and also contamination of waste lotion samples are prevented from being contaminated. When a consumer's hand activates the dispensing outlet 12 (e.g. through detection from motion sensor 14), door 17 retracts allowing waste sample to travel through the receiving aperture into the drip tray. Thus, in the preferred embodiment, the dispensing outlet 12 and door 17 are simultaneously activated through a mechanism involving detection from motion sensor 14.

Each unit of sample may range in size from about 0.1 to about 5 ml, preferably from about 0.3 to about 1 ml, optimally about 0.5 ml dispensed per consumer interaction.

A light emitting diode (LED) indicator light 18 is arranged on a front wall of the housing. It is activated upon product in the reservoir 8 reaching a pre-determined level of remaining undispensed product.

The device may be fitted with a pump system 20 within the housing for delivering product to the outlet 12. This pump system may be a peristaltic pump mechanism. Preferably a pump such as an electrically operated pump will not be present within the device. Reliance on gravity feed is preferred so as to avoid the relatively expensive component of a pump and its attendant failure possibilities.

A SD card 22 is placed within the housing for storing recorded information. The information may be received from a digital counter which tracks frequency of use and time of day. The SD card is in a section of the housing from which it can be removed and transferred to a central location outside the store for evaluation of data recorded therein. The retail store can then discard the remainder of the emptied device to allow recycling of plastic components.

A battery or set of batteries 24 is included within the housing. The battery provides power to the LED, motion sensor and (when present) pumping system.

The reservoir 8 may be sized about 3 to 100, preferably 5 to 50, optimally 10 to 20 times greater in product volume capacity than a product volume capacity of the retail packaged product.

While the principles of this invention have been described in connection with specific embodiments, it should be understood that these descriptions are made only by way of example and are not intended to limit the scope of the invention.

What is claimed is:

1. A device which allows a consumer prior to purchase to test a skin lotion or cream product in a retail establishment, the device comprising:
a housing formed from recycled plastic and sealed from entry by the consumer, external walls of the housing having at least three panel areas for communicating marketing information;
at least one electrical battery within the housing;
a reservoir within the housing for storing the product;
a dispensing outlet allowing exit from the reservoir of a unit sample of the product;
a motion sensor for detecting presence of a consumer's hand near an area of the outlet; and
a drip tray beneath the outlet for collecting any wastage of the sample not intercepted by a consumer's hand.

2. The device according to claim 1 further comprising a light emitting diode indicator activated upon product in the reservoir reaching a pre-determined level of remaining undispensed product.

3. The device according to claim 1 wherein the drip tray has a product capacity from about 5 to about 25% by volume of an initially fully filled reservoir.

4. The device according to claim 1 wherein the reservoir is a flexible wall plastic pouch lodged inside walls of the reservoir.

5. The device according to claim 1 further comprising a pump system within the housing for delivering product to the outlet.

6. The device according to claim 1 wherein an electrically operated pump is not present in the device.

7. The device according to claim 1 further comprising a valve upstream from the outlet and being controlled from a closed to an open position by the motion sensor.

8. The device according to claim 1 further comprising an SD card for storing recorded information.

9. The device according to claim 1 further comprising a digital counter for recording day and time of each sample dispensing event.

10. The device according to claim 1 wherein at least one of the panel areas exhibits an image of retail packaging for the product which has been dispensed.

11. The device according to claim 1 wherein the reservoir is sized about 3 to 100 times greater than a product volume capacity of retail packaging for same product.

12. The device according to claim 1 further comprising an aperture in a roof of the drip tray aligned with the dispensing outlet to accept a lotion or cream product into the drip tray that has not been intercepted by the consumer's hand.

13. The device according to claim 12 further comprising a door movable from an open to a closed position across the aperture in the roof of the drip tray, the door being activated by the motion sensor for detecting presence of the consumer's hand.

14. A method for allowing a consumer prior to purchase to test a skin lotion or cream product in a retail establishment, the method comprising:
(i) providing a device for placement on a shelf of a retail establishment, the device comprising:
a housing formed from recycled plastic and sealed from entry by the consumer, external walls of the housing having at least three panel areas for communicating marketing information;
at least one electrical battery within the housing;
a reservoir within the housing for storing the product;
a dispensing outlet allowing exit from the reservoir of a unit sample of the product;
a motion sensor for detecting presence of a consumer's hand near an area of the outlet;
a drip tray beneath the outlet for collecting any wastage of the sample not intercepted by the consumer's hand; and
(ii) allowing a consumer to place a hand near an area of the outlet to receive a unit sample of product; and
(iii) placing packaged product bottles on a shelf adjacent the device to allow consumer to connect the unit sample with the appropriate packaged bottle and to have the latter purchased.

15. The method according to claim 14 wherein the device further comprises an opening in a roof of the drip tray aligned with the dispensing outlet to accept a lotion or cream product into the drip tray that has not been intercepted by the consumer's hand.

16. The method according to claim 15 wherein the device further comprises a door movable from an open to a closed position across the aperture in the roof of the drip tray, the door being activated by the motion sensor for detecting presence of the consumer's hand.
